(19) United States
(12) Patent Application Publication
(10) Pub. No.: US 2024/0140162 A1
(43) Pub. Date: May 2, 2024

(54) THERMAL MANAGEMENT SYSTEM FOR AN ELECTRIC VEHICLE, AND COMBINATION VALVE FOR A THERMAL MANAGEMENT SYSTEM

(71) Applicant: HELLA GmbH & Co. KGaA, Lippstadt (DE)

(72) Inventor: Sebastian TIEMEYER, Dortmund (DE)

(73) Assignee: HELLA GmbH & Co. KGaA, Lippstadt (DE)

(21) Appl. No.: 18/407,292

(22) Filed: Jan. 8, 2024

Related U.S. Application Data
(63) Continuation of application No. PCT/EP2022/050075, filed on Jan. 4, 2022.

(30) Foreign Application Priority Data
Jul. 8, 2021 (DE) 10 2021 117 644.1
Aug. 20, 2021 (DE) 10 2021 121 607.9

(51) Int. Cl. B60H 1/00; B60L 58/26; B60L 58/27

(52) U.S. Cl. CPC B60H 1/00278; B60H 1/00485; B60H 1/00921; B60L 58/26; B60L 58/27; B60H 2001/00307; B60H 2001/00928; B60H 2001/00949

(57) ABSTRACT

A thermal management system for an electric vehicle, the thermal management system comprising: a battery circuit having a first coolant pump for a coolant, a battery, and a chiller; a drive circuit having a second coolant pump for the coolant, an electric motor, power electronics for controlling the electric motor, and a heat sink for dissipating heat to open surroundings; and a refrigerant circuit for a refrigerant for controlling the temperature of an interior of the electric vehicle having a compressor, in each case for heat exchange with the interior, an interior condenser, and an interior evaporator, a condenser, at least one throttle, and the chiller for heat exchange with the battery circuit. The thermal management system is designed such that the chiller, in relation to the battery circuit, can be operated both in a cooling mode for cooling the battery and in a heating mode for heating the battery.

This nonprovisional application is a continuation of International Application No. PCT/EP2022/050075, which was filed on Jan. 4, 2022, and which claims priority to German Patent Application Nos. 10 2021 117 644.1, which was filed on Jul. 8, 2021, and 10 2021 121 607.9, which was filed on Aug. 20, 2021, and which are all herein incorporated by reference.

### BACKGROUND OF THE INVENTION

### Field of the Invention

The invention relates to a thermal management system for an electric vehicle and to a combination valve for a thermal management system.

### Description of the Background Art

Thermal management systems for electric vehicles, with or without a combination valve, are known from the conventional art and comprise a battery circuit having a first coolant pump for a coolant, a battery, and a chiller; a drive circuit having a second coolant pump for the coolant, an electric motor, power electronics for controlling the electric motor, and a heat sink for dissipating heat to open surroundings; and a refrigerant circuit for a refrigerant for controlling the temperature of an interior of the electric vehicle having a compressor, in each case for heat exchange with the interior, an interior condenser, and an interior evaporator, a condenser, at least one throttle, and the chiller for heat exchange with the battery circuit.

### SUMMARY OF THE INVENTION

The invention thus addresses the problem of improving a thermal management system for an electric vehicle and a combination valve for a thermal management system.

According to an example of the invention, this problem is solved by a thermal management system, which is characterized in that the chiller, in relation to the battery circuit, can be operated both in a cooling mode for cooling the battery and in a heating mode for heating the battery. The electric vehicle equipped with the thermal management system of the invention can be designed as a purely electric vehicle or a so-called hybrid vehicle, in which an internal combustion engine is also provided in addition to the electric drive for the vehicle with an electric motor. The refrigerant circuit is technically identical to a heat pump. Further, said problem is solved by a combination valve for a thermal management system with the features of claim 13. Advantageous embodiments and refinements of the invention emerge from the following dependent claims.

The advantage achievable with the invention is, in particular, that a thermal management system for an electric vehicle and a combination valve for a thermal management system are improved. Due to the design of the invention for the thermal management system for an electric vehicle and for the combination valve for a thermal management system, it is possible that, in addition to the switching of the condenser from the cooling to the heating mode, which is already known from the prior art, according to the invention the chiller can also be operated in both a cooling and a heating mode in relation to the battery circuit. This enables efficient heating of the battery with a COP (coefficient of performance)>>1, which significantly improves the overall efficiency of the electric vehicle equipped with it. The combination valve makes this possible in a particularly advantageous way in terms of design and production technology.

The thermal management system of the invention can be freely selected within wide suitable limits in terms of type, function, material, and dimensioning.

At least one of the at least one throttle can be designed as an expansion valve, preferably as a freely controllable expansion valve, particularly preferably that all throttles of the at least one throttle are each designed as an expansion valve. In this way, the at least one throttle is very advantageously designed for use in electric vehicles. This applies in particular to the preferred and particularly to the very preferred embodiment of this refinement.

The refrigerant circuit can be designed as follows in terms of flow conduction: a first connection of the compressor is connected to a first connection of the interior condenser, a second connection of the interior condenser is connected to a first connection of a first multiway valve, the first multiway valve is connected with a second connection to a first connection of the condenser and to a first connection of a second multiway valve, and with a third connection to a second connection of the second multiway valve and to a first connection of the chiller; the condenser is connected with a second connection to a first connection of a first throttle, the first throttle is connected with a second connection to a first connection of a second throttle and to a first connection of a third throttle; a second connection of the second throttle is connected to a second connection of the chiller and a second connection of the third throttle is connected to a first connection of the interior evaporator, and a second connection of the interior evaporator is connected to a second connection of the compressor and to a third connection of the second multiway valve. This makes the design of the thermal management system of the invention, in particular of the refrigerant circuit of the thermal management system of the invention, particularly easy to realize in terms of design, production technology, and process engineering. Moreover, the present refinement of the invention reduces the number of valves, required for the functionality of the thermal management system of the invention, in the refrigerant circuit to a minimum, so that a cost-optimized implementation is made possible. The aforementioned flow-conducting connections can be designed both directly and indirectly, with the fluidic interposition of an additional component of the refrigerant circuit.

The first multiway valve and the second multiway valve can each be designed as a 3/2-way valve, and that the refrigerant circuit has a first and a second check valve, wherein, on the one hand, a first connection of the first check valve on the blocking direction side is connected to the second connection of the condenser and to the first connection of the first throttle and, on the other hand, a second connection of the first check valve on the opening direction side is connected to the second connection of the first throttle and in each case to the first connection of the second and third throttle, and wherein, on the one hand, a first connection of the second check valve on the blocking direction side is connected in each case to the second connection of the chiller and the second throttle and, on the other hand, a second connection of the second check valve on the opening direction side is connected, firstly, in each case to the second connection of the first throttle and to the first check valve, and, secondly, in each case to the first connection of the second and third throttle. In this way, the thermal management system of the invention can be realized in a particularly simple manner. In the thus improved thermal management system, the interior condenser is arranged downstream of the compressor and can be used at any time to heat the interior, that is, to transfer heat from the refrigerant circuit to the interior of the electric vehicle. By closing air flaps in a climate control system of the electric vehicle, of which system the refrigerant circuit is a component, the interior condenser can be thermally insulated if necessary, so that the transfer of heat to the interior is prevented in this case. Alternatively, the interior condenser can also be bypassed by a further 3/2-way multiway valve.

The first multiway valve, which is fluidically arranged downstream of the interior condenser and is designed as a 3/2-way valve, enables switching between a cooling mode and a heating mode, in each case in relation to the battery circuit. In the cooling mode, the condenser is the heat sink and transfers heat to the open surroundings, whereas in the heating mode, the chiller can transfer heat to the battery circuit. In the heating mode, the transfer of heat to the battery can be prevented, if desired, by switching off the coolant pump in the battery circuit and thus ending the flow of coolant through the chiller. The refrigerant flows into the high-pressure region of the refrigerant circuit via the first and second check valves either by bypassing the respective expansion valve at the condenser or at the chiller and is then available for expansion at the other expansion valves. The second multiway valve, designed as a 3/2-way valve, ensures the return of the expanded refrigerant from the chiller in the cooling mode or from the condenser in the heating mode.

The first multiway valve can be designed as a 4/3-way valve and the second multiway valve as a 3/3-way valve, wherein a fourth connection of the first multiway valve is connected to the second connection of the first throttle, on the one hand, and in each case to the first connection of the second and third throttles, on the other. The aforementioned first and second check valves are unnecessary if the expansion valves used are freely adjustable and can be opened to a cross section that is sufficient for the flow of refrigerant into the high-pressure region of the refrigerant circuit. This also applies to other embodiments of the thermal management system of the invention. The further advantage is the additional connection to the high-pressure region. For this purpose, the first multiway valve is designed here as a 4/3-way valve. The additional connection in the high-pressure region enables a further heating mode in which the expansion valves of the condenser and chiller can be used simultaneously or separately. This corresponds to a combined heat pump, which can simultaneously utilize ambient heat via the condenser as well as waste heat from the drive circuit via the battery circuit, namely, the chiller. The second multiway valve, designed as a 3/3-way valve, has a third state here which allows the refrigerant to flow back simultaneously out of the condenser and chiller.

A reservoir for the refrigerant may typically be required in a refrigerant circuit. This can be arranged in the high-pressure region as a so-called receiver/dryer fluidically downstream of the heat exchanger in which condensation takes place, or in the low-pressure region as a so-called accumulator fluidically directly upstream of the compressor. The accumulator has advantages in the heating mode, whereas the receiver/dryer has advantages in the cooling mode.

An accumulator for the refrigerant can be fluidically interposed in the refrigerant circuit between the compressor, on the one hand, and the indoor evaporator and the second multiway valve, on the other hand, wherein the accumulator is connected with a first connection to the second connection of the compressor and with a second connection firstly to the second connection of the interior evaporator and secondly to a third connection of the second multiway valve.

A storage container for the refrigerant can be fluidically interposed in the refrigerant circuit between the fourth connection of the first multiway valve, on the one hand, and the first, second, and third throttle, on the other hand, wherein, on the one hand, a first connection of the storage container is connected firstly to the fourth connection of the first multiway valve and secondly in each case to a first connection of a third check valve and a fourth check valve on the opening direction side, and, on the other hand, a second connection of the storage container is connected to the second connection of the first throttle and in each case to the first connection of the second and third throttles, and wherein, on the one hand, a second connection of the third check valve on the blocking direction side is connected to the second connection of the condenser and the first connection of the first throttle and, on the other hand, a second connection of the fourth check valve on the blocking direction side is connected in each case to the second connection of the chiller and the second throttle. The first multiway valve, which is arranged downstream of the interior condenser and is designed as a 4/3-way valve, enables switching between a cooling mode or a first heating mode, in each case in relation to the battery circuit. In the cooling mode, the condenser is the heat sink and transfers heat to the surroundings, whereas in the first heating mode, the chiller can transfer heat, for example, obtained via the condenser as an ambient heat pump, to the battery circuit. The refrigerant flows into the high-pressure region of the refrigerant circuit via one of the two check valves, either by bypassing the respective expansion valve at the condenser or at the chiller, and is then available for expansion at the respective other expansion valves.

In the case of the reservoir formed as the accumulator and also as the storage container, namely, the receiver/dryer, there is the limitation that these components have only one flow direction. For this reason, the latter example represents an advantageous refinement, as the two check valves can ensure a single flow direction. Accordingly, a receiver/dryer can be provided alone or in addition to the accumulator and contribute to an improvement of the efficiency in the cooling mode.

In a second heating mode, also in relation to the battery circuit, the refrigerant flows directly downstream of the 4/3-way valve into the high-pressure region. This makes possible a simultaneous use of the expansion valves of the condenser and chiller. This corresponds to a combined heat pump, which can simultaneously utilize the ambient heat via the condenser as well as the waste heat from the drive circuit via the battery circuit, namely, the chiller. The return of the refrigerant to the compressor is realized via a 3/3-way valve according to the present refinement. Compared to the aforementioned embodiments of the invention, the present refinement of the thermal management system of the invention has a storage container for the refrigerant in the high-pressure region, which is also known as a receiver/dryer (R/D for short) and offers efficiency advantages over refrigerant circuits, therefore, heat pumps, with an accumulator.

A particularly advantageous refinement of the thermal management system of the invention provides that the first and second multiway valves can be combined structurally and in terms of circuit technology to form a single combination valve such that the combination valve can be controlled by means of a single controller of the thermal management system as a single multiway valve functionally similar to the first and second multiway valves, which are separate from one another structurally and in terms of circuit technology. As a result, the fluidic connections, required in the aforementioned refinements, between the two structurally separate multiway valves are realized internally in the combination valve, namely, in the combination valve of the invention. This integrated variant thus enables further cost savings by reducing the number of separate refrigerant lines and control units while retaining the same functionality.

The storage container can be arranged on a housing of the combination valve, preferably that the storage container is designed as an integral part of the housing of the combination valve. In this way, the design and manufacture of the refrigerant circuit of the thermal management system is further simplified. Moreover, in the preferred embodiment of this refinement, corresponding lines between the two components can be omitted. Accordingly, this integrated variant enables additional cost savings by further reducing the number of refrigerant lines.

The refrigerant circuit can comprise a heat exchanger for heat transfer between a refrigerant return from the storage container to the combination valve and a refrigerant return from the combination valve to the compressor, preferably that the heat exchanger is formed as an integral part of a housing of the combination valve. In this way, heat can be transferred from the high-pressure region to the low-pressure region, so that the efficiency of the thermal management system, namely, the refrigerant circuit, is further improved. The aforementioned heat exchanger can be designed, for example, as a coaxial line. In the preferred embodiment of the present refinement, the high-pressure region and the low-pressure region are located moreover in thermally conductive contact in the housing of the combination valve. Refrigerant lines and energy can again be economized as a result.

The third and/or fourth check valve can each be arranged on a housing of the combination valve, preferably that the third and/or fourth check valve can each be formed as an integral part of the housing of the combination valve. In this way, the degree of integration in the thermal management system of the invention is further increased. This applies in particular to the preferred embodiment of this refinement.

The condenser and/or the chiller can be arranged on a housing of the combination valve. This makes it possible to save on additional refrigerant lines.

In principle, the combination valve of the invention for a thermal management system can be freely selected within wide suitable limits in terms of type, function, material, and dimensioning.

An advantageous refinement of the combination valve of the invention for a thermal management system provides that the first and second multiway valves are arranged in a common housing, preferably that the first and second multiway valves are arranged one above the other in the common housing, particularly preferably that the first multiway valve is designed as a 4/3-way valve and the second multiway valve as a 3/3-way valve. As a result, the combination valve of the invention can be realized in a very advantageous manner in terms of design and production technology. This applies in particular to the preferred and particularly to the very preferred embodiment of this refinement.

A further advantageous refinement of the combination valve of the invention for a thermal management system provides that the first and second check valves and/or the third and fourth check valves and/or the first expansion valve and/or the second expansion valve and/or the third expansion valve can be additionally arranged in a common housing for the first and second multiway valve. In this way, the space-saving and therefore compact design of the combination valve of the invention is further improved.

An advantageous refinement of the aforementioned embodiment of the combination valve of the invention for a thermal management system provides that the first and second check valves and/or the third and fourth check valves, on the one hand, and the first expansion valve and/or the second expansion valve and/or the third expansion valve, on the other hand, can be arranged one above the other in the housing, preferably that the aforementioned check valves are arranged in one plane with the first multiway valve and the at least one expansion valve is arranged in one plane with the second multiway valve. This further improves the implementation of the design and production technology of the combination valve of the invention.

Another advantageous refinement of the combination valve of the invention for a thermal management system provides that connecting channels can be arranged in a common housing for the first and second multiway valve for the flow-conducting connection of the first multiway valve to the second multiway valve, preferably for the flow-conducting connection of the first multiway valve to the check valves and/or of the second multiway valve to the at least one expansion valve and/or for the flow-conducting connection of the check valves to the at least one expansion valve, particularly preferably for the flow-conducting connection of the first plane to the second plane. In this way, the design and manufacture of the combination valve of the invention is further simplified and the combination valve as a whole can be realized in a very compact and thus space-saving manner.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of the thermal management system of the invention in a process engineering flow diagram;

FIG. 2a shows an analogous representation to FIG. 1, in a partial view with the refrigerant circuit in a first variant, in a cooling mode;

FIG. 2b shows the example according to FIG. 2a, in a heating mode;

FIG. 3a shows the example in an analogous representation to FIG. 2a, in a partial view with the refrigerant circuit in a second variant, in the cooling mode;

FIG. 3b shows the example according to FIG. 3a, in a first heating mode;

FIG. 3c shows the example according to FIG. 3a, in a second heating mode;

FIG. 4a shows in an analogous representation to FIG. 2a, in a partial view with the refrigerant circuit in a third variant, in the cooling mode;

FIG. 4b shows the example according to FIG. 4a, in a first heating mode;

FIG. 4c shows the example according to FIG. 4a, in a second heating mode;

FIG. 5 shows the example in an analogous representation to FIG. 2a, in a partial view with the refrigerant circuit in a fourth variant;

FIG. 6 shows the example in an analogous representation to FIG. 2a, in a partial view with the refrigerant circuit in a fifth variant;

FIG. 7 shows the example in an analogous representation to FIG. 2a, in a partial view with the refrigerant circuit in a sixth variant;

FIG. 8a shows a combination valve corresponding to the cooling mode according to FIG. 4a;

FIG. 8b shows the combination valve analogous to FIG. 8a, with the combination valve corresponding to the first heating mode according to FIG. 4b; and

FIG. 8c shows the combination valve analogous to FIG. 8a, with the combination valve corresponding to the second heating mode according to FIG. 4c.

### DETAILED DESCRIPTION

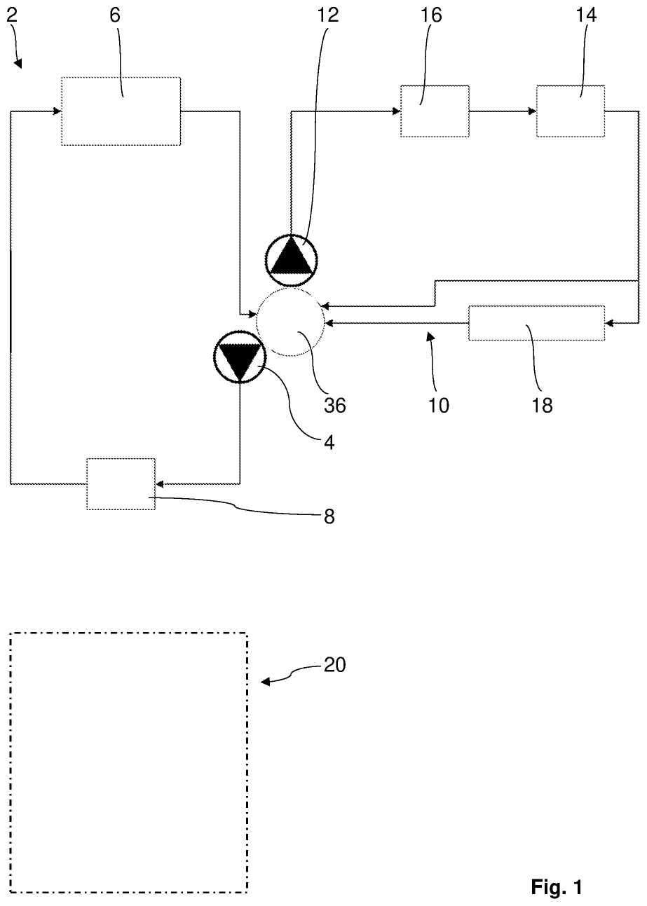

An example of the thermal management system of the invention for an electric vehicle and an example of the combination valve of the invention for the thermal management system are shown in FIGS. 1 to 8c purely as an example.

The thermal management system for an electric vehicle, for example, a passenger car having a purely electric drive, here comprises a battery circuit 2 having a first coolant pump 4 for a coolant, a battery 6, and a chiller 8; a drive circuit 10 having a second coolant pump 12 for the coolant, an electric motor 14, power electronics 16 for controlling electric motor 14 and a heat sink 18 designed as a radiator for dissipating heat to the open surroundings; and a refrigerant circuit 20 for a refrigerant, for controlling the temperature of an interior of the electric vehicle having a compressor 22, in each case for heat exchange with the interior, an interior condenser 24, and an interior evaporator 26, a condenser 28, a first, second, and third throttle 30, 32, 34, and chiller 8 for heat exchange with battery circuit 2. In the present exemplary embodiment, battery circuit 2 and drive circuit 10 can be connected by means of a multiway valve 36 in a coolant-conducting manner. See FIG. 1 in this regard. Throttles 30, 32, 34 are each designed as an expansion valve, namely, as a freely controllable expansion valve. In a preferred manner, refrigerant circuit 20, therefore, the heat pump of the thermal management system, uses the ambient heat via condenser 28 according to the present exemplary embodiment. Condenser 28 can be realized as an air-refrigerant heat exchanger or as a coolant-refrigerant heat exchanger. In the following, reference is made exclusively to the first version of condenser 28, but an implementation according to the second embodiment of the condenser is also conceivable.

The thermal management system can be designed in such a way that chiller 8, in relation to battery circuit 2, can be operated both in a cooling mode for cooling battery 6 and in a heating mode for heating battery 6.

The refrigerant circuit can be designed as follows in terms of flow conduction: a first connection of compressor 22 is connected to a first connection of interior condenser 24, a second connection of interior condenser 24 is connected to a first connection of a first multiway valve 38, the first multiway valve 38 is connected with a second connection to a first connection of condenser 28 and to a first connection of a second multiway valve 40, and with a third connection to a second connection of second multiway valve 40 and to a first connection of chiller 8; condenser 28 is connected with a second connection to a first connection of first throttle 30, first throttle 30 is connected with a second connection to a first connection of a second throttle 32 and a first connection of a third throttle 34; a second connection of second throttle 32 is connected to a second connection of chiller 8 and a second connection of third throttle 34 is connected to a first connection of interior evaporator 26; and a second connection of interior evaporator 26 is connected to a second connection of compressor 22 and to a third connection of second multiway valve 40.

Based on the aforementioned basic fluidic structure of refrigerant circuit 20 in the present exemplary embodiment, various variants of this refrigerant circuit 20 are explained below by way of example.

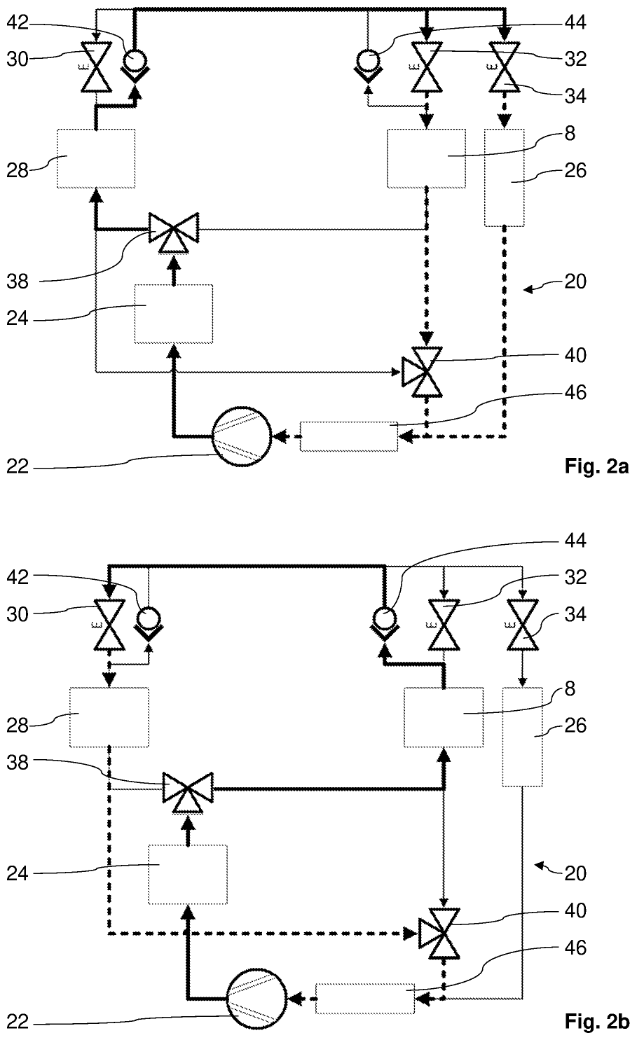

In the first variant of refrigerant circuit 20 shown in FIGS. 2a and 2b, first multiway valve 38 and second multiway valve 40 are each designed as a 3/2-way valve, and refrigerant circuit 20 has a first and a second check valve 42, 44, wherein, on the one hand, a first connection of first check valve 42 on the blocking direction side is connected to the second connection of condenser 28 and to the first connection of first throttle 30 and, on the other hand, a second connection of first check valve 42 on the opening direction side is connected to the second connection of first throttle 30 and in each case to the first connection of second and third throttle 32, 34, and wherein, on the one hand, a first connection of second check valve 44 on the blocking direction side is connected in each case to the second connection of chiller 8 and second throttle 32, and, on the other hand, a second connection of second check valve 44 on the opening direction side is connected firstly in each case to the second connection of first throttle 30 and to first check valve 42, and secondly in each case to the first connection of second and third throttles 32, 34. In refrigerant circuit 20 in the present variant, an accumulator 46 for the refrigerant is fluidically interposed between compressor 22, on the one hand, and interior evaporator 26 and second multiway valve 40, on the other, wherein accumulator 46 is connected with a first connection to the second connection of compressor 22 and with a second connection firstly to the second connection of interior evaporator 26 and secondly to the third connection of second multiway valve 40. The flow through the high-pressure region of refrigerant circuit 20 is indicated by thick black lines, whereas the flow through the low-pressure region is shown by dashed lines. This also applies accordingly to the other variants of refrigerant circuit 20.

In the thermal management system designed in this way, interior condenser 24 is arranged fluidically downstream of compressor 22 and can be used at any time to heat the interior, that is, to transfer heat from refrigerant circuit 20 to the interior of the electric vehicle. By closing air flaps in a climate control system of the electric vehicle, of which system refrigerant circuit 20 is a component, interior condenser 24 can be thermally insulated if necessary, so that the transfer of heat to the interior is prevented in this case. Alternatively, the interior condenser can also be bypassed by a further 3/2-way multiway valve.

First multiway valve 38, which is arranged downstream of interior condenser 24 and is designed as a 3/2-way valve, enables switching between a cooling mode shown in FIG. 2a and a heating mode shown in FIG. 2b, in each case in relation to battery circuit 2. In the cooling mode, condenser 28 is the heat sink and transfers heat to the open surroundings, whereas in the heating mode, chiller 8 can transfer heat to battery circuit 2. In the heating mode, the transfer of heat to battery 6 can be prevented, if desired, by switching off coolant pump 4 in battery circuit 2 and thus ending the flow of coolant through chiller 8. The refrigerant flows into the high-pressure region of refrigerant circuit 20 via first and second check valves 42, 44 either by bypassing expansion valve 30, 32 at condenser 28 or at chiller 8 and is then available for expansion at the other expansion valves 30, 32, 34. Second multiway valve 40, designed as a 3/2-way valve, ensures the return of the expanded refrigerant from chiller 8 in the cooling mode or from condenser 28 in the heating mode.

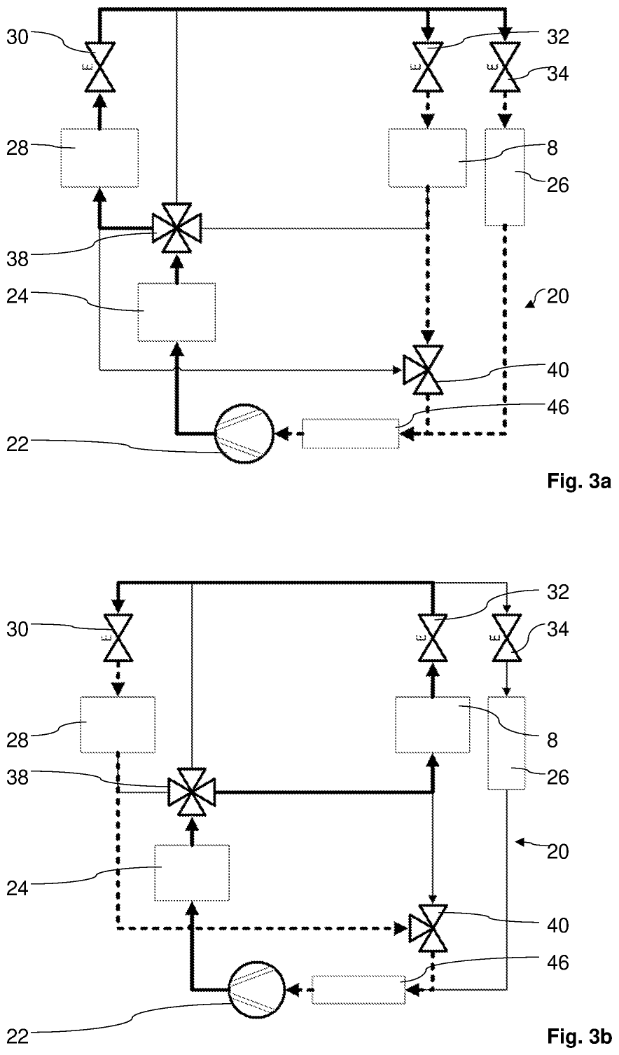

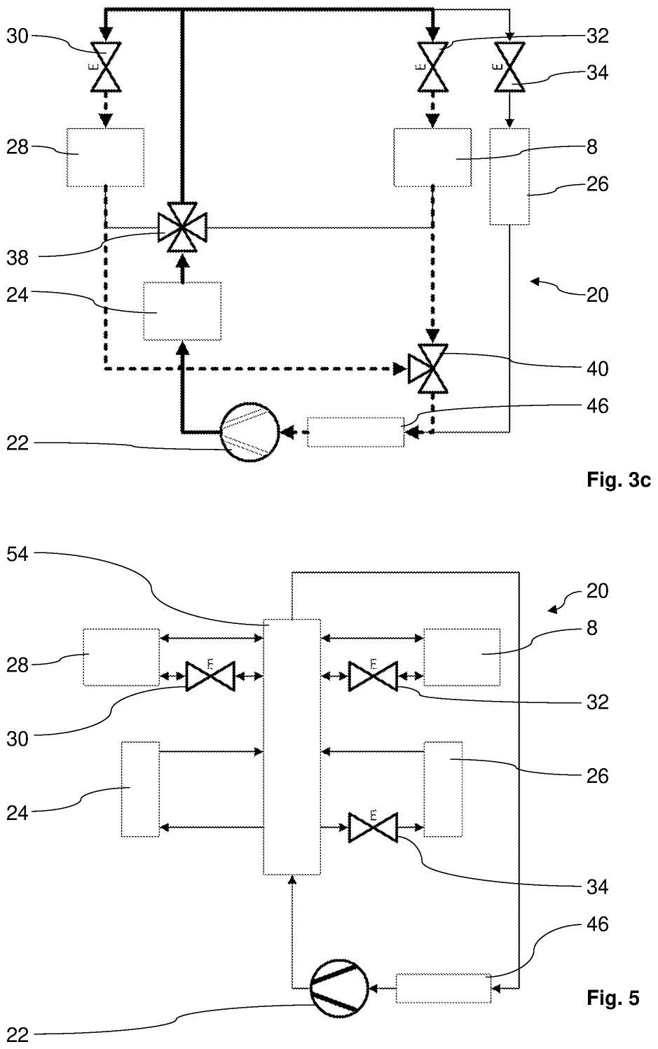

FIGS. 3a to 3c show a second variant of refrigerant circuit 20. In this second variant, first multiway valve 38 is designed as a 4/3-way valve and second multiway valve 40 as a 3/3-way valve, wherein a fourth connection of first multiway valve 38 is connected to the second connection of first throttle 30, on the one hand, and in each case to the first connection of second and third throttles 32, 34, on the other.

As a result, the aforementioned first and second check valves 42, 44 of the first variant are unnecessary. This is possible if the expansion valves 30, 32, 34 used, as in the present exemplary embodiment, are freely controllable and can be opened to a cross section which is sufficient for the flow of refrigerant through the high-pressure region of refrigerant circuit 20. The further advantage is the additional connection to the high-pressure region. For this purpose, first multiway valve 38 is designed here as a 4/3-way valve. The additional connection in the high-pressure region enables a further heating mode in which a simultaneous or separate use of expansion valves 30, 32 of condenser 28 and chiller 8 is possible. See FIG. 3c in this regard. This corresponds to a combined heat pump, which can simultaneously utilize the ambient heat via condenser 28 as well as the waste heat from drive circuit 10 via battery circuit 2, namely, chiller 8. Second multiway valve 40, designed as a 3/3-way valve, has a third state here which allows the refrigerant to flow back simultaneously out of condenser 28 and chiller 8.

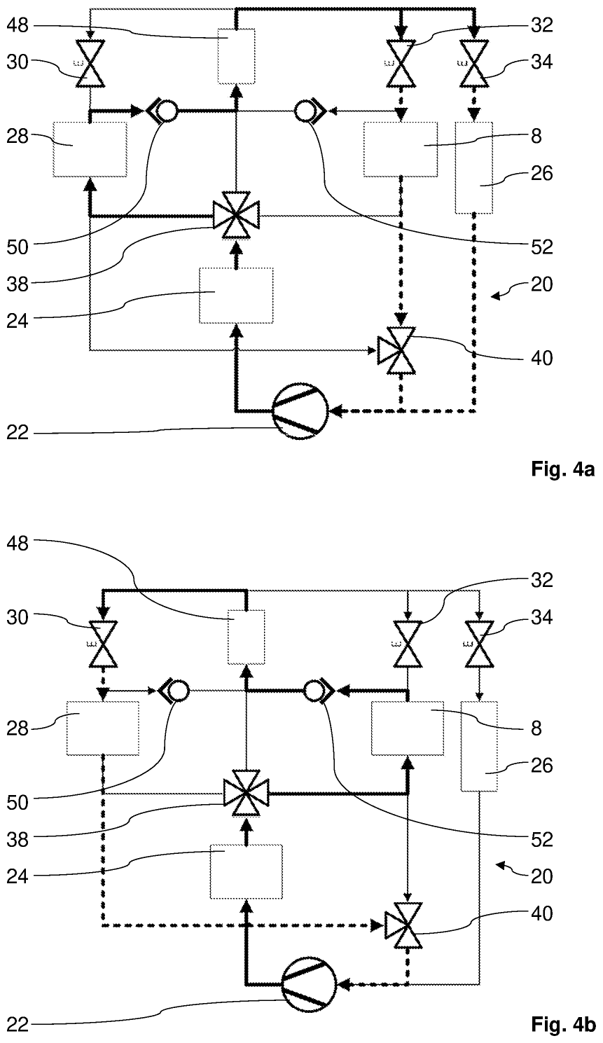

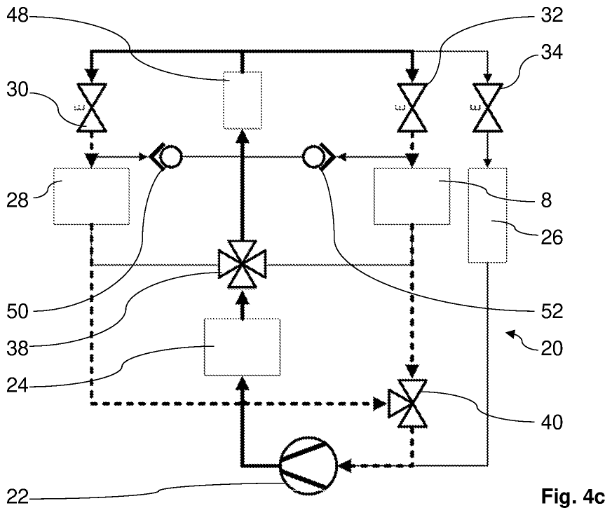

FIGS. 4a to 4c show a third variant of refrigerant circuit 20. In refrigerant circuit 20 of this third variant, a storage container 48 for the refrigerant is fluidically interposed between the fourth connection of first multiway valve 38, on the one hand, and the first, second, and third throttles 30, 32, 34, on the other hand, instead of the above-mentioned accumulator 46, wherein, on the one hand, a first connection of storage container 48 is connected firstly to the fourth connection of first multiway valve 38 and secondly in each case to a first connection of a third check valve 50 and a fourth check valve 52 on the opening direction side, and, on the other hand, a second connection of storage container 48 is connected to the second connection of first throttle 30 and in each case to the first connection of the second and third throttles 32, 34, and wherein, on the one hand, a second connection of the third check valve 50 on the blocking direction side is connected to the second connection of condenser 28 and the first connection of first throttle 30 and, on the other hand, a second connection of fourth check valve 52 on the blocking direction side is connected in each case to the second connection of chiller 8 and second throttle 34 in each case. Check valves 50, 52 of this variant are referred to as third and fourth check valves 50, 52 merely to distinguish them from the first and second check valves 42, 44 of the first variant.

First multiway valve 38, which is arranged downstream of interior condenser 24 and is designed as a 4/3-way valve, enables switching between a cooling mode shown in FIG. 4a and a first heating mode shown in FIG. 4b, in each case again in relation to the battery circuit. In the cooling mode, condenser 28 is the heat sink and transfers heat to the open surroundings, whereas in the first heating mode, chiller 8 can transfer heat, for example, obtained via condenser 28 as an ambient heat pump, to battery circuit 2. The refrigerant flows into the high-pressure region of refrigerant circuit 20 via one of check valves 50, 52 either by bypassing the respective expansion valve 30, 32 at condenser 28 or at chiller 8 and is then available for expansion at the respective other expansion valves 30, 32, 34.

In a second heating mode shown in FIG. 4c, the refrigerant flows directly downstream of first multiway valve 38, which is designed as a 4/3-way valve, into the high-pressure region. This makes possible a simultaneous use of expansion valves 30, 32 of condenser 28 and chiller 8. This corresponds to a combined heat pump, which can simultaneously utilize the ambient heat via condenser 28 as well as the waste heat from drive circuit 10 via battery circuit 2, namely, chiller 8. According to the present variant, the return of the refrigerant to compressor 22 is realized via second multiway valve 40, which is designed as a 3/3-way valve. Compared to the aforementioned variants, the variant of refrigerant circuit 20 here has storage container 48 for the refrigerant in the high-pressure region, which is also known as the receiver/dryer (R/D for short) and offers efficiency advantages over refrigerant circuits 20, therefore, the heat pumps, with accumulator 46.

In a fourth variant of refrigerant circuit 20 according to FIG. 5, the first and second multiway valves 38, 40 of the aforementioned variants with accumulator 46 are combined structurally and in terms of circuit technology to form a single combination valve 54 such that combination valve 54 can be controlled by means of a single controller of the thermal management system as a single multiway valve functionally similar to the first and second multiway valves, which are separate from one another structurally and in terms of circuit technology, for example, the aforementioned multiway valves 38, 40.

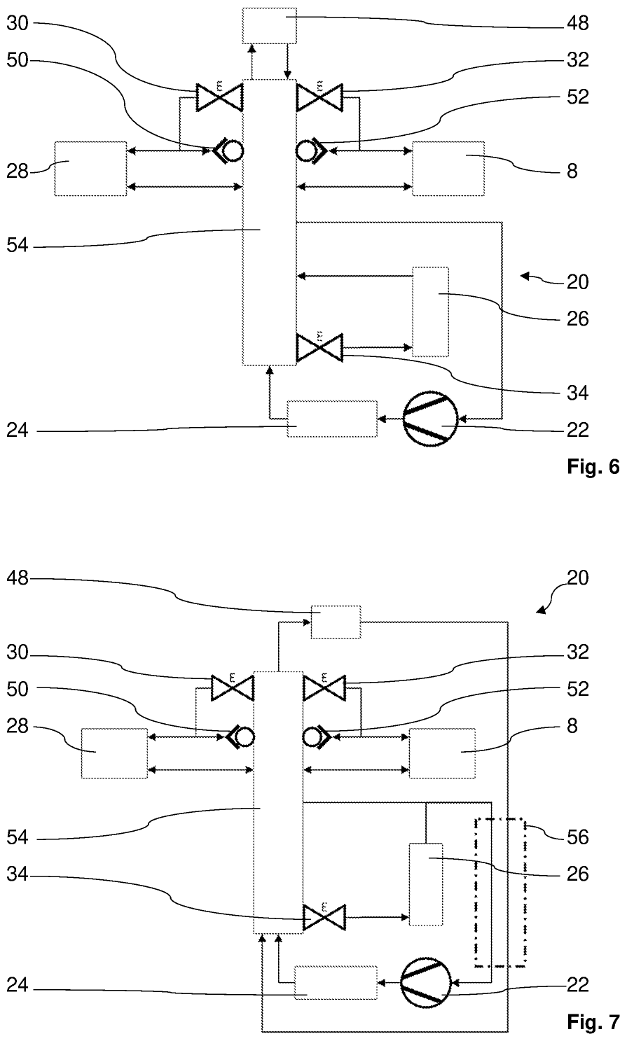

FIG. 6 shows a fifth variant of refrigerant circuit 20, wherein storage container 48 according to the third variant of refrigerant circuit 20 is formed as an integral part of a housing of combination valve 54.

Further, a sixth variant of refrigerant circuit 20 according to FIG. 7 provides that refrigerant circuit 20 comprises a heat exchanger 56 for heat transfer between a refrigerant return from storage container 48 according to the third variant of refrigerant circuit 20 to combination valve 54 and a refrigerant return from combination valve 54 to compressor 22, namely, such that heat exchanger 56 is formed as an integral part of a housing of combination valve 54. Heat exchanger 56 is designed here as a coaxial line.

Moreover, in other embodiments of the invention, for example, in other variants of the refrigerant circuit of the present exemplary embodiment, it is conceivable that the third and/or fourth check valve are/is each arranged on a housing of the combination valve, preferably that the third and/or fourth check valve are/is each formed as an integral part of the housing of the combination valve, and/or that the condenser and/or the chiller are/is arranged on a housing of the combination valve.

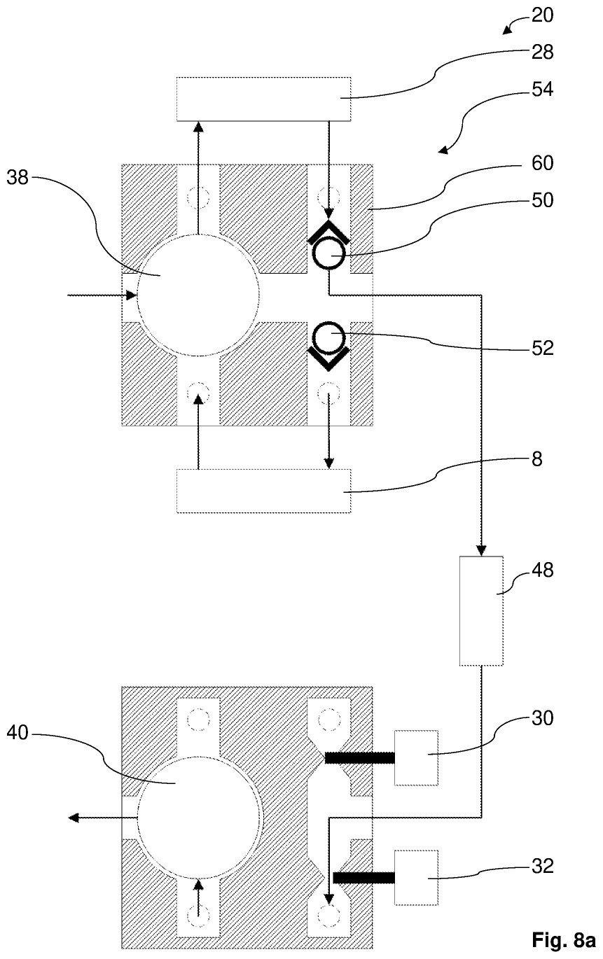

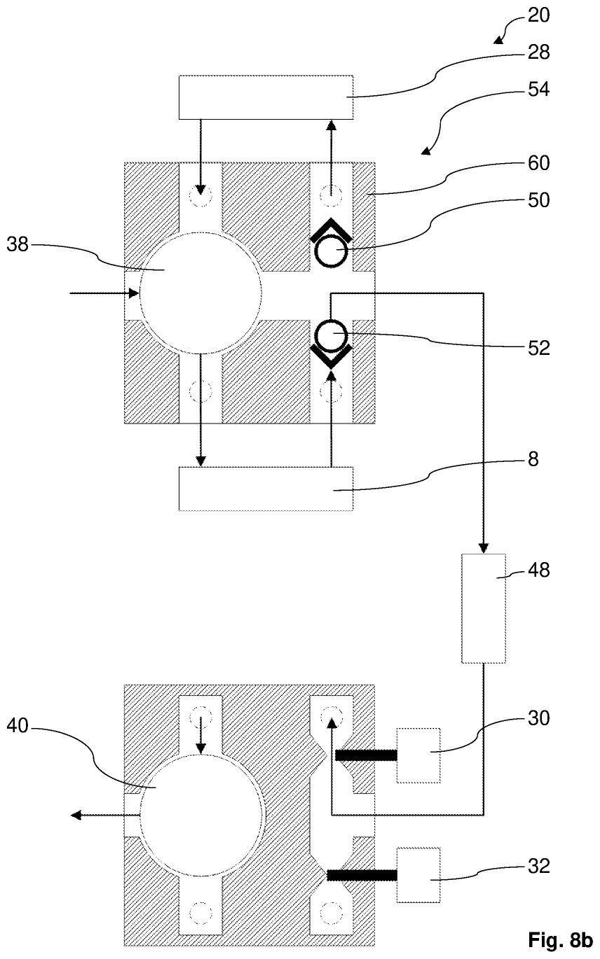

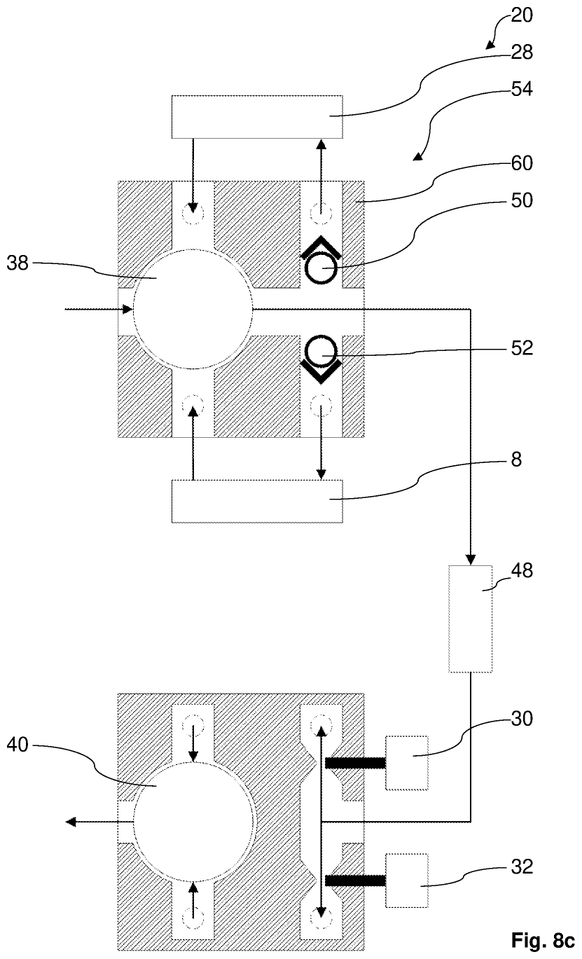

For example, a combination valve of the invention is shown as an example in FIGS. 8a to 8c. In each of FIGS. 8a to 8c, combination valve 54 is shown in the present embodiment, wherein a first cross section through combination valve 54 is shown at the top and a second cross section through said valve is shown at the bottom in the respective image plane of FIGS. 8a to 8c.

Combination valve 54 according to FIGS. 8a to 8c corresponds to the third variant of refrigerant circuit 20 shown in FIGS. 4a to 4c, wherein combination valve 54 according to FIG. 8a corresponds to refrigerant circuit 20 according to FIG. 4a, combination valve 54 according to FIG. 8b corresponds to refrigerant circuit 20 according to FIG. 4b, and combination valve 54 according to FIG. 8c corresponds to refrigerant circuit 20 according to FIG. 4c. Accordingly, reference is also made here to the above comments on the third variant of refrigerant circuit 20 according to FIGS. 4a to 4c.

As emerges from FIGS. 8a to 8c, the first and second multiway valves are combined structurally and in terms of circuit technology to form single combination valve 54 according to the present embodiment such that combination valve 54 can be controlled by means of a single controller of thermal management system 20 as a single multiway valve functionally similar to the first and second multiway valves, which are separate from one another structurally and in terms of circuit technology. For the sake of simplicity, the same reference characters are used for the first and second multiway valves 38, 40 according to the present embodiment of combination valve 54 as for refrigerant circuit 20 of the thermal management system according to FIGS. 4a to 4c.

As already described in the comments on FIGS. 4a to 4c, first and second multiway valves 38, 40 are not only arranged in a common housing 60 according to the present embodiment of the combination valve of the invention, but first multiway valve 38 is designed as a 4/3-way valve and second multiway valve 40 as a 3/3-way valve, wherein first and second multiway valves 38, 40 are arranged one above the other in the common housing 60, namely, such that first multiway valve 38 is arranged in housing 60 in a first plane above second multiway valve 40 in a second plane. The first plane with first multiway valve 38 is shown at the top in the image plane of the respective FIGS. 8a to 8c and the second plane with second multiway valve 40 is shown at the bottom in the image plane of the respective FIGS. 8a to 8c. First and/or second multiway valve 38, 40 can be a disc valve or a ball valve, for example. Different valve designs are also conceivable for the first and second multiway valves 38, 40.

In addition to the first and second multiway valves 38, 40, third and fourth check valves 50, 52, and first expansion valve and second expansion valve 30, 32 are arranged in housing 60, wherein third and fourth check valves 50, 52, on the one hand, and first expansion valve 30 and second expansion valve 32, on the other hand, are arranged one above the other in housing 60, namely, such that the aforementioned check valves 50, 52 are arranged in the first plane with first multiway valve 38 and expansion valves 30, 32 in the second plane with second multiway valve 40. For the sake of simplicity, the same reference characters are used for check valves 50, 52 and expansion valves 30, 32 according to the present embodiment of combination valve 54 as for refrigerant circuit 20 of the thermal management system according to FIGS. 4a to 4c.

As emerges further from FIGS. 8a to 8c, connecting channels are arranged in the common housing 60 for first and second multiway valves 38, 40 for the flow-conducting connection of first multiway valve 38 to second multiway valve 40, for the flow-conducting connection of first multiway valve 38 to check valves 50, 52 and of second multiway valve 40 to expansion valves 30, 32 and for the flow-conducting connection of check valves 50, 52 to expansion valves 30, 32. The connecting channels connecting the first and second planes in a flow-conducting manner are shown with dashed lines in FIGS. 8a to 8c.

Combination valve 54 constructed in the aforementioned manner according to FIGS. 4a to 4c is connected in a flow-conducting manner to the other components of the third variant of refrigerant circuit 20 of the thermal management system. See the above comments in this regard. For example, the arrows in the respective image plane of FIGS. 8a to 8c at the top indicate the flow-conducting connection of combination valve 54 to interior condenser 24 and the arrows in the respective image plane of FIGS. 8a to 8c at the bottom indicate the flow-conducting connection of combination valve 54 to compressor 22.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A thermal management system for an electric vehicle, the thermal management system comprising:
a battery circuit having a first coolant pump for a coolant, a battery, and a chiller;
a drive circuit having a second coolant pump for the coolant, an electric motor, power electronics for controlling the electric motor, and a heat sink for dissipating heat to open surroundings; and
a refrigerant circuit for a refrigerant for controlling the temperature of an interior of the electric vehicle having a compressor for heat exchange with the interior, an interior condenser, and an interior evaporator, a condenser, at least one throttle, and the chiller for heat exchange with the battery circuit, the thermal management system being designed such that the chiller, in relation to the battery circuit, is adapted to be operated both in a cooling mode for cooling the battery and in a heating mode for heating the battery.

2. The thermal management system according to claim 1, wherein at least one of the at least one throttle is designed as an expansion valve or as a freely controllable expansion valve, or wherein all throttles of the at least one throttle are each designed as an expansion valve.

3. The thermal management system according to claim 1, wherein the refrigerant circuit is designed as follows in terms of flow conduction: a first connection of the compressor is connected to a first connection of the interior condenser, a second connection of the interior condenser is connected to a first connection of a first multiway valve, the first multiway valve is connected with a second connection to a first connection of the condenser and to a first connection of a second multiway valve, and with a third connection to a second connection of the second multiway valve and to a first connection of the chiller; the condenser is connected with a second connection to a first connection of a first throttle; the first throttle is connected with a second connection to a first connection of a second throttle and to a first connection of a third throttle; a second connection of the second throttle is connected to a second connection of the chiller and a second connection of the third throttle is connected to a first connection of the interior evaporator; and a second connection of the interior evaporator is connected to a second connection of the compressor and to a third connection of the second multiway valve.

4. The thermal management system according to claim 3, wherein the first multiway valve and the second multiway valve are each designed as a 3/2-way valve, and wherein the refrigerant circuit has a first and a second check valve, wherein, a first connection of the first check valve on the blocking direction side is connected to the second connection of the condenser and to the first connection of the first throttle and a second connection of the first check valve on the opening direction side is connected to the second connection of the first throttle and to the first connection of the second and third throttle, and wherein a first connection of the second check valve on the blocking direction side is connected to the second connection of the chiller and the second throttle and a second connection of the second check valve on the opening direction side is connected to the second connection of the first throttle and the first check valve and to the first connection of the second and third throttle.

5. The thermal management system according to claim 3, wherein the first multiway valve is a 4/3-way valve and the second multiway valve is a 3/3-way valve, wherein a fourth connection of the first multiway valve is connected to the second connection of the first throttle and to the first connection of the second and third throttles.

6. The thermal management system according to claim 3, wherein an accumulator for the refrigerant is fluidically interposed in the refrigerant circuit between the compressor and the interior evaporator and the second multiway valve, wherein the accumulator is connected with a first connection to the second connection of the compressor and with a second connection to the second connection of the interior evaporator and to a third connection of the second multiway valve.

7. The thermal management system according to claim 5, wherein a storage container for the refrigerant is fluidically interposed in the refrigerant circuit between the fourth connection of the first multiway valve and the first, second, and third throttle, wherein, a first connection of the storage container is connected to the fourth connection of the first multiway valve and to a first connection of a third check valve and of a fourth check valve on an opening direction side, and a second connection of the storage container is connected to the second connection of the first throttle and to the first connection of the second and third throttles, and wherein a second connection of the third check valve on the blocking direction side is connected to the second connection of the condenser and the first connection of the first throttle, and a second connection of the fourth check valve on the blocking direction side is connected to the second connection of the chiller and the second throttle.

8. The thermal management system according to claim 3, wherein the first and second multiway valves are combined structurally and in terms of circuit technology to form a single combination valve such that the combination valve is controlled by a single controller of the thermal management system as a single multiway valve functionally similar to the first and second multiway valves, which are separate from one another structurally and in terms of circuit technology.

9. The thermal management system according to claim 8, wherein the storage container is arranged on a housing of the combination valve or wherein the storage container is designed as an integral part of the housing of the combination valve.

10. The thermal management system according to claim 8, wherein the refrigerant circuit comprises a heat exchanger for heat transfer between a refrigerant return from the storage container to the combination valve and a refrigerant return from the combination valve to the compressor or wherein the heat exchanger is formed as an integral part of a housing of the combination valve.

11. The thermal management system according to claim 8, wherein the third and/or fourth check valve are/is each arranged on a housing of the combination valve or wherein the third and/or fourth check valve are/is each formed as an integral part of the housing of the combination valve.

12. The thermal management system according to claim 8, wherein the condenser and/or the chiller are/is arranged on a housing of the combination valve.

13. A combination valve for the thermal management system according to claim 8, wherein the first and second multiway valves are combined structurally and in terms of circuit technology to form a single combination valve such that the combination valve is controllable by a single controller of the thermal management system as a single multiway valve functionally similar to the first and second multiway valves, which are separate from one another structurally and in terms of circuit technology.

14. The combination valve according to claim 13, wherein the first and second multiway valves are arranged in a common housing or wherein the first and second multiway valves are arranged one above the other in the common housing or wherein the first multiway valve is a 4/3-way valve and the second multiway valve is a 3/3-way valve.

15. The combination valve according to claim 13, wherein the first and second check valves and/or the third and fourth check valves and/or the first expansion valve and/or the second expansion valve and/or the third expansion valve are/is additionally arranged in a common housing for the first and second multiway valve.

16. The combination valve according to claim 15, wherein the first and second check valves and/or the third and fourth check valves and the first expansion valve and/or the second expansion valve and/or the third expansion valve are arranged one above the other in the housing or wherein the check valves are arranged in one plane with the first multiway valve and the at least one expansion valve is arranged in one plane with the second multiway valve.

17. The combination valve according to claim 13, wherein connecting channels are arranged in a common housing for the first and second multiway valve for the flow-conducting connection of the first multiway valve to the second multiway valve or for the flow-conducting connection of the first multiway valve to the check valves and/or of the second multiway valve to the at least one expansion valve and/or for the flow-conducting connection of the check valves to the at least one expansion valve or for the flow-conducting connection of the first plane to the second plane.
